(19) United States
(12) Patent Application Publication
(10) Pub. No.: US 2011/0043967 A1
(43) Pub. Date: Feb. 24, 2011

(54) Super capacitor and method of fabricating the same

(75) Inventors: Hak Kwan Kim, Hanam (KR); Hyun Chul Jung, Yongin (KR); Jun Hee Bae, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,304

(22) Filed: Dec. 16, 2009

(30) Foreign Application Priority Data
Jun. 9, 2009 (KR) 10-2009-0051160

(51) Int. Cl. H01G 9/004; H01G 13/00

(52) U.S. Cl. 361/523; 29/25.03

(57) ABSTRACT

There is provided a super capacitor and a method of fabricating the same. The method includes providing a substrate in which a plurality of nanoholes are formed, forming a first electrode layer on one face of the substrate, filling the nanoholes with a conductive material to form conductive nanowires, removing the substrate such that the conductive nanowires are placed on the first electrode layer, forming a solid electrolyte layer on the first electrode layer on which the conductive nanowires are formed, and forming a second electrode layer on the solid electrolyte layer, the second electrode layer being separated from the first electrode layer.

### CROSS-REFERENCE TO RELATED APPLICATIONS

This application claims the priority of Korean Patent Application No. 10-2009-0051160 filed on Jun. 9, 2009 in the Korean Intellectual Property Office, the disclosure of which is incorporated herein by reference.

### BACKGROUND OF THE INVENTION

1. Field of the Invention

The present invention relates to a super capacitor, and more particularly, to a super capacitor and a method of fabricating the same, which can ensure high electrical conductivity and high capacitance with a wide surface area while simplifying a structure and a fabrication process thereof.

2. Description of the Related Art

A stable energy supply has become more crucial in a variety of electronic products such as information communications devices. In general, this energy supply is performed by capacitors. Capacitors store and supply electricity in circuits for various electronic products, and stabilize the flow of electricity in the circuits. Typical capacitors have long useful lives, short charge and discharge periods and high output density, however they have considerably low energy density, which cause limitations in using these typical capacitors as storage devices.

Therefore, new types of capacitors are under development, such as super capacitors having superior output density while having short charge and discharge periods. Such capacitors are drawing much attention as new generation energy storage device, along with secondary batteries.

Super capacitors are classified into three types according to electrode materials and mechanisms. That is, super capacitors may be classified into the following types: electric double layer capacitors (EDLCs) using activated carbon as electrodes and adopting an electric-charge absorption mechanism in electrical double layers; metal oxide electrode pseudo-capacitors (also referred to as ‘redox capacitors’) using transition metal oxides and conductive polymers for electrodes and adopting a mechanism associated with pseudo-capacitance; and hybrid capacitors having intermediate characteristics of the EDLCs and the redox (electrolytic) capacitors.

Among those capacitors, EDLC type super capacitors that utilize activated carbon materials are currently the most widely used capacitors.

The basic structure of an EDLC type super capacitor includes an electrode having a relatively large surface area such as a porous electrode, an electrolyte, a current collector, and a separator. The EDLC type super capacitor operates on the basis of an electrochemical mechanism generated as ions in the electrolyte flow along an electric field due to a voltage being applied to both terminals of a unit cell electrode, and are absorbed onto an electrode surface.

As for EDLC type capacitors using activated carbon as an electrode material, since their specific capacitance is proportional to the specific surface area, the activated carbon renders an electrode porous, thereby increasing energy density according to the capacitance of the electrode material. The porous electrode material may be activated carbon, activated carbon fiber, amorphous carbon, a carbon aerogel, a carbon composite material, or a carbon nanotube.

However, despite the high specific surface area of the activated carbon, the activated carbon has the following limitations. The pores of the activated carbon are mostly fine pores having a diameter of about 20 nm or less, which do not contribute to the function of an electrode, and effective pores thereof are merely 20% of the entire pores. Furthermore, an electrode, in actuality, is fabricated by mixing a binder, a carbon conductive agent, a solvent or the like to produce a slurry. This further reduces the actual effective contact area between an electrode and an electrolyte. In addition, the degree of contact resistance between an electrode and a current collector, and a capacitance range thereof vary according to fabrication methods.

As for redox capacitors using a metal oxide as an electrode material, a transition metal oxide is advantageous in terms of capacitance and has lower resistance than activated carbon. For this reason, the metal oxide may contribute to fabricating a high-output super capacitor. Also, it has been known that using an amorphous hydrate as an electrode material increases the specific capacitance of an electrode significantly. Although having higher capacitance than EDLC type capacitors, these redox capacitors have the following limitations: manufacturing costs which are more than double those of EDLC type, a high degree of difficulty in the manufacturing process, and high parasitic serial resistance (ESR).

Of late, electrodes have been provided which are formed by oxidizing only a surface using nitride having superior electric conductivity to that of an oxide. These electrodes may have superior output and energy density properties, as compared to existing electrodes solely using transition metal oxides.

As for hybrid capacitors developed in an effort to incorporate the advantages of the above capacitors, studies are being actively conducted in order to increase operating voltage and enhance energy density by using an asymmetric electrode structure. In detail, one electrode utilizes a material having the characteristic of an electrode double layer, that is, carbon, thereby maintaining an output characteristic, and the other electrode utilizes an electrode implementing a redox mechanism with a high-capacitance characteristic, so that a hybrid capacitor achieves enhanced overall cell energy.

Although capacitance and energy density can be enhanced in the aforementioned manner, properties regarding charge/discharge or the like have not been optimized yet, and the non-linearity of such hybrid capacitors hinders the generalization thereof.

Moreover, the importance of an electrolyte might be neglected due to the fact that operating voltage has a significant influence on energy density. However, a liquid electrolyte, regardless of whether it is aqueous or organic, is being widely used in actual fabrication processes.

However, the liquid electrolyte is disadvantageous in terms of reproducibility, liquid leakage, corrosion and stability at high temperatures. Therefore, gel type electrolytes have recently been developed by mixing a polymer with a liquid electrolyte; however, they still fail to ensure high conductivity and require high manufacturing costs.

### SUMMARY OF THE INVENTION

An aspect of the present invention provides a method of fabricating a super capacitor having a novel structure that can ensure high electrical conductivity and high capacitance with a wide surface area.

An aspect of the present invention also provides a super capacitor that has high electrical conductivity and high capacitance with a wide surface area while simplifying its structure and fabrication process.

According to an aspect of the present invention, there is provided a method of fabricating a super capacitor, including: providing a substrate in which a plurality of nanoholes are formed; forming a first electrode layer on one face of the substrate; filling the nanoholes with a conductive material to form conductive nanowires; removing the substrate such that the conductive nanowires are placed on the first electrode layer; forming a solid electrolyte layer on the first electrode layer on which the conductive nanowires are formed; and forming a second electrode layer on the solid electrolyte layer, the second electrode layer being separated from the first electrode layer.

The substrate may be an anodized alumina (AAO) substrate.

At least one of the first and second electrode layers may include a metallic electrode. At least one of the first and second electrode layers may be formed by an evaporation method or a sputtering process.

The conductive nanowires may include a metallic material. In this case, the forming of the conductive nanowires may be performed by an electroplating process.

The solid electrolyte layer may be formed of LiF. In this case, the forming of the solid electrolyte layer may be performed by a thermal vapor deposition process. Also, the forming of the solid electrolyte layer may include injecting vapor in order to increase the mobility of Li ions.

According to another aspect of the present invention, there is provided a super capacitor including: a first electrode structure having a first electrode layer and a plurality of conductive nanowires arranged on the first electrode layer; a solid electrolyte layer disposed on a face of the first electrode structure in which the conductive nanowires are arranged; and a second electrode structure having a second electrode layer disposed on the solid electrolyte layer to separate the second electrode layer from the first electrode layer.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1F are schematic cross-sectional views for explaining a method of fabricating a super capacitor according to an exemplary embodiment of the present invention;

FIG. 2 is a perspective view illustrating an anodized aluminum oxide substrate depicted in FIG. 1A;

FIG. 3 is a perspective view illustrating a first electrode layer including a nanowire depicted in FIG. 1D; and

FIG. 4 is a partial cut-out perspective view illustrating one example of a super capacitor depicted in FIG. 1F.

### DETAILED DESCRIPTION OF THE PREFERRED EMBODIMENT

Exemplary embodiments of the present invention will now be described in detail with reference to the accompanying drawings.

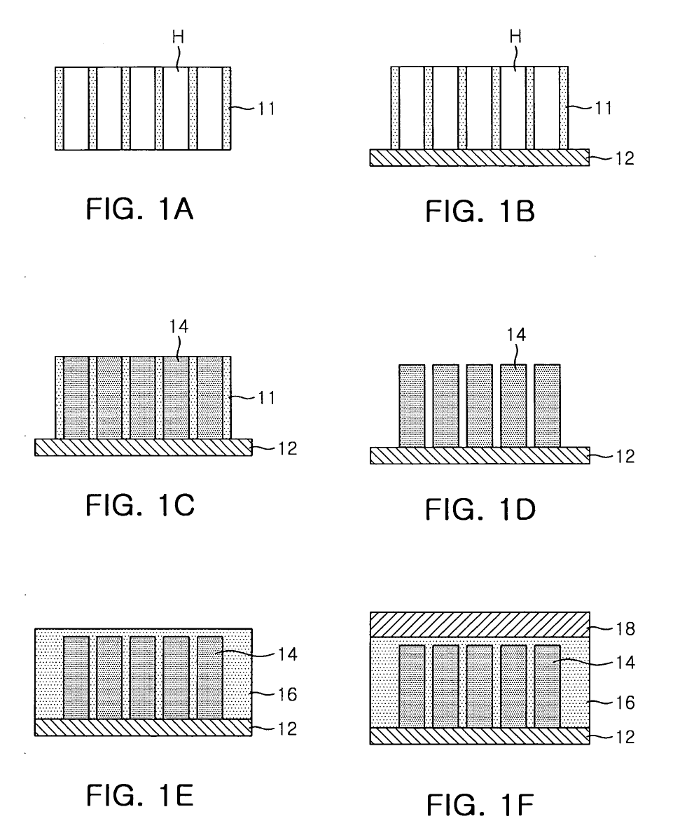

FIGS. 1A through 1F are schematic cross-sectional views for explaining a method of fabricating a super capacitor according to an exemplary embodiment of the present invention.

As shown in FIG. 1A, this embodiment begins with providing a substrate 11 having a plurality of nanoholes H.

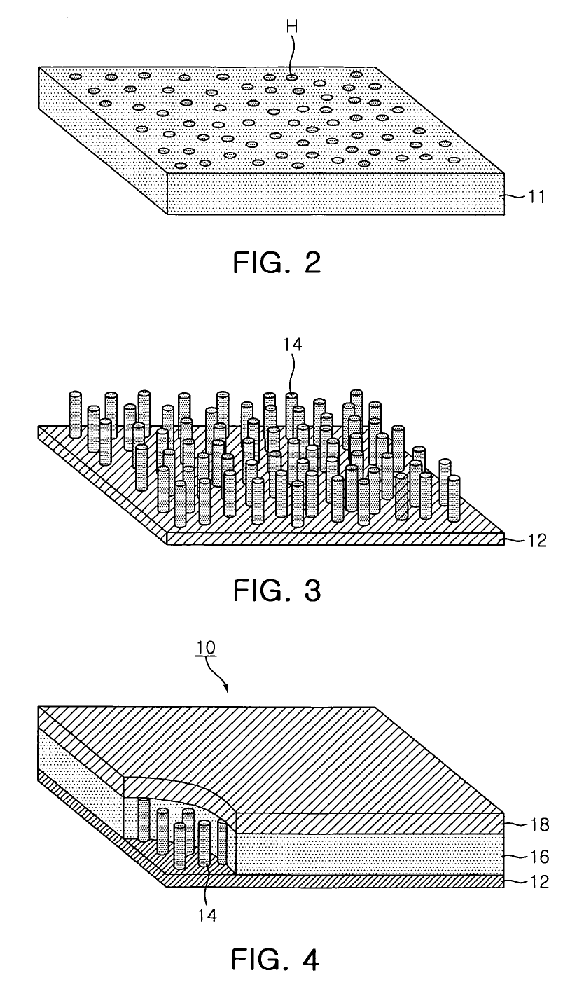

The substrate 11 is used as a mold for obtaining a nanowire. The substrate 11 in which the plurality of nanoholes H are formed may be formed of an anodized aluminum oxide (AAO). As shown in FIG. 2, the nanoholes H are each provided in the form of a tube having a nanoscale diameter, and are formed in the thickness direction of the AAO substrate 11. The nanoholes H may be randomly distributed over the entire area of the AAO substrate 11.

Thereafter, as shown in FIG. 1B, a first electrode layer 12 is formed on the bottom face of the AAO substrate 11.

The first electrode layer 12 may contain a metal such as Au, Ag, Ni, Cu or Pt. The first electrode layer 12 itself is formed of metal having high electrical conductivity, thereby significantly enhancing current collection efficiency as compared to activated carbon according to the related art. The first electrode layer 12 may be formed by an evaporation method or a sputtering process, however the present invention is not limited thereto. For example, other known methods such as electroless plating may be used, or a fabricated electrode plate may be attached to the bottom surface of the AAO substrate 12.

Thereafter, as shown in FIG. 1C, the nanoholes H are filled with a conductive material, thereby forming conductive nanowires 14.

The conductive nanowires 14 may utilize any material having electrical conductivity, such as a polymer, however it may be formed of a metallic material ensuring high conductivity. The metallic material may be at least one selected from the group consisting of Au, Ag, Ni, Cu and Pt, or may be the same material as the first electrode layer 12. An electroplating process may be used when the conductive nanowires 14 are formed of a metallic material.

As shown in FIG. 1D, the substrate 11 is removed, leaving the conductive nanowires 14 on the first electrode layer 12.

This process may be performed using an etching solution capable of selectively removing a substrate material while causing almost no damage to the first electrode layer 12 and the conductive nanowires 14. For example, a resultant structure depicted in FIG. 1C is impregnated with sodium hydroxide of 5 wt % to 10 wt % for 0.5 hours to 20 hours, thereby selectively removing the AAO substrate 11.

Through the process of removing the substrate 11, a nanowire array of the nanowires 14 may be provided on the first electrode layer 12 as shown in FIG. 3. The nanowire array is provided as one electrode structure, together with the first electrode layer 12. The nanowires 14 may contribute to increasing capacitance significantly, by greatly increasing the specific surface area of one electrode.

As shown in FIG. 1E, a solid electrolyte layer 16 is formed on the first electrode layer 12 on which the conductive nanowires 14 are formed.

The solid electrolyte layer 16 may be formed to cover the conductive nanowires 14. The solid electrolyte layer 16 needs to be formed such that a second electrode layer to be formed in a subsequent process does not directly contact the conductive nanowires 14 connected to the first electrode layer 12.

The use of a solid electrolyte, rather than a liquid electrolyte, may render an element such as a separator unnecessary. Accordingly, the structure and fabrication process of the super capacitor can be simplified.

A material that may be used for the solid electrolyte layer 16 according to this embodiment may be lithium fluoride (LiF). LiF, although being a ceramic material, may encompass the conductive nanowires through a simple thermal vapor deposition process due to its low melting point of about 845° C. In addition, in the event that a solid LiF electrolyte layer 16 is employed, the mobility of Li ions may be increased by injecting vapor during the thermal vapor deposition process.

The second electrode layer 18 is formed on the solid electrolyte layer 16, and is separated from the first electrode layer 12.

According to this embodiment, the second electrode layer 18 may face the first electrode layer 12 with the solid electrolyte layer interposed therebetween. Like the first electrode layer 12, the second electrode layer 18 may utilize Au, Ag, Ni, Cu or Pt. Similarly to the first electrode layer 12, the second electrode layer 18 itself may be formed of a metallic material having high electrical conductivity, and this may enhance current collecting efficiency significantly.

The second electrode layer 18 may be formed by an evaporation method or a sputtering process. However, the present invention is not limited to the aforementioned methods, the second electrode layer 18 may be formed by using another known method such as electrodeless plating. Alternatively, the second electrode layer 18 may be realized by attaching a previously fabricated electrode plate to the top face of the solid electrolyte layer 16.

As shown in FIG. 4, the super capacitor 10 includes a first electrode structure having the first electrode layer 12 and the plurality of conductive nanowires 14 arranged on the first electrode layer 12, the solid electrolyte layer 16 formed on the face of the first electrode structure where the conductive nanowires 14 are arranged, and a second electrode structure having the second electrode layer 18 formed on the solid electrolyte layer 16 and separated from the first electrode layer 12.

Due to the arrangement of the conductive nanowires 14, the surface area of the first electrode structure increases considerably. Also, the use of the solid electrolyte layer 16 achieves a simpler structure since an element such as a separator is omitted. In particular, the surface area of an electrode, according to this embodiment, can be considerably increased by forming a plurality of metallic nanowires using an alumina mold. Also, since the current collector itself is formed of a metallic material, the electrode has superior electrical conductivity to the related art carbon-based electrode. Accordingly, current collected by the charge absorption reaction on the surface can be immediately released with small loss, and the charging capacity can be enhanced considerably.

As set forth above, according to exemplary embodiments of the invention, there is provided a super capacitor, which can achieve an increase in the surface area of an electrode and employs a solid electrolyte allowing for the omission of an element such as a separator, and a method of fabricating the same.

In particular, the surface area of an electrode, according to this embodiment, can be significantly increased by forming a plurality of metallic nanowires using an alumina mold. Also, since the current collector itself is formed of a metallic material, the electrode has superior electrical conductivity to the related art carbon-based electrode. Accordingly, current collected by the charge absorption reaction on the surface can be immediately released with small loss, and the charging capacity can be enhanced considerably.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of fabricating a super capacitor, the method comprising:
providing a substrate in which a plurality of nanoholes are formed;
forming a first electrode layer on one face of the substrate;
filling the nanoholes with a conductive material to form conductive nanowires;
removing the substrate such that the conductive nanowires are placed on the first electrode layer;
forming a solid electrolyte layer on the first electrode layer on which the conductive nanowires are formed; and
forming a second electrode layer on the solid electrolyte layer, the second electrode layer being separated from the first electrode layer.

2. The method of claim 1, wherein the substrate is an anodized alumina (AAO) substrate.

3. The method of claim 1, wherein at least one of the first and second electrode layers comprises a metallic electrode.

4. The method of claim 3, wherein at least one of the first and second electrode layers is formed by an evaporation method or a sputtering process.

5. The method of claim 1, wherein the conductive nanowires comprise a metallic material.

6. The method of claim 5, wherein the forming of the conductive nanowires is performed by an electroplating process.

7. The method of claim 1, wherein the solid electrolyte layer is formed of LiF.

8. The method of claim 7, wherein the forming of the solid electrolyte layer is performed by a thermal vapor deposition method.

9. The method of claim 8, wherein the forming of the solid electrolyte layer comprises injecting vapor in order to increase the mobility of Li ions.

10. A super capacitor comprising:
a first electrode structure having a first electrode layer and a plurality of conductive nanowires arranged on the first electrode layer;
a solid electrolyte layer disposed on a face of the first electrode structure in which the conductive nanowires are arranged; and
a second electrode structure having a second electrode layer disposed on the solid electrolyte layer to separate the second electrode layer from the first electrode layer.

11. The super capacitor of claim 10, wherein the substrate is an anodized alumina (AAO) substrate.

12. The super capacitor of claim 10, wherein at least one of the first and second electrode layers comprises a metallic electrode.

13. The super capacitor of claim 10, wherein the conductive nanowires comprise a metallic material.

14. The super capacitor of claim 10, wherein the solid electrolyte layer comprises LiF.
